(19) United States
(12) Patent Application Publication
(10) Pub. No.: US 2024/0401980 A1
(43) Pub. Date: Dec. 5, 2024

(54) Computer-Implemented Method and System for Improving the Signal Quality of Sensor Data

(71) Applicant: Siemens Aktiengesellschaft, Muenchen (DE)

(72) Inventors: Ezgi AYVAZOGLU CELIKKOL, Kadikoy, Istanbul (TR); Asiye ULUSOY, Istanbul (TR); Gizem MUSLU TASTAN, Istanbul (TR); Burcu ARDIC SERPEN, Istanbul (TR); Erman KORKMAZ, Kadiköy, Istanbul (TR); Mustafa GONUL, Kagithane, Istanbul (TR)

(21) Appl. No.: 18/700,784

(22) PCT Filed: Oct. 12, 2022
(86) PCT No.: PCT/EP2022/078450

§ 371 Date: Apr. 12, 2024

(30) Foreign Application Priority Data
Oct. 14, 2021 (EP) 21202624

(51) Int. Cl. G01D 3/036

(52) U.S. Cl. CPC G01D 3/0365

(57) ABSTRACT

Computer-implemented method for improving the signal quality of a first sensor data, wherein the first sensor data is captured by a first sensor, which is environmentally coupled to a first technical device, and at least one second sensor data is captured by at least one second sensor, where the at least one second sensor is environmentally decoupled from the first technical device, and a correlation function is calculated by a processor with a memory, which is connected with the first and at least one second sensor, using the first and the at least one second sensor data to estimate the background noise, to which background noise the first and at least one second sensor are exposed simultaneously, and the correlation function is used to reduce the background noise of the first sensor data.

### CROSS-REFERENCE TO RELATED APPLICATIONS

This is a U.S. national stage of application No. PCT/EP2022/078450 filed 12 Oct. 2022. Priority is claimed on European Application No. 21202624.9 filed 14 Oct. 2021, the content of which is incorporated herein by reference in its entirety.

### BACKGROUND OF THE INVENTION

### 1. Field of the Invention

The invention relates to a computer-implemented method for improving the signal quality of a first sensor data, where the first sensor data is captured by a first sensor, which is environmentally coupled to a first technical device, and at least one second sensor data is captured by at least one second sensor.

### 2. Detailed Description of the Related Art

Several devices like low-voltage motors are used in industrial environment, for instance, at a production line, in drives for manufacturing machines or transportation devices or transportation vehicles.

Low-voltage motors are electromechanical machines that do not expose any information about their operation. Consequently, external sensors often need to be mounted for tracking the motor condition, such as the sensor Siemens SIMOTICS CONNECT 400 (SC400) and SIDRIVE IQ Fleet for low-voltage motor diagnostics.

The measurements of such sensors, e.g., the SC400, which are built for low voltage applications, are often negatively affected by vibration, temperature and the magnetic field generated by other devices in the environment or the environment itself. Incorrect measurements can create false alarms, corrupt the data, and makes the data unreliable for motor diagnostic and machine learning algorithms. Such a sensor has no ability to use the data of other sensors in order to eliminate the ambient interference. Moreover, depending on the applied measurement method, a low signal-to-noise-ratio can disadvantageously affect the captured measurement results due to a low signal level and a high background noise level.

In conventional statistical methods are currently used, for instance, in cloud applications to eliminate the noise and correct the distortion. However, such methods can lead to lose the accuracy of the measurements, which can have undesired negative consequences.

First, the system can create false alarms, for instance, when a motor vibration higher than the norm values might be caused by the other machines in the shopfloor.

Second, the system might miss an anomaly due to the suppressing effect of the ambient conditions, for instance, very low ambient temperature might suppress the temperature of the motor.

### SUMMARY OF THE INVENTION

It is an objective of the invention to improve the signal quality of sensor data, which are disturbed by environmental noise, in a simple way.

This and other objects and advantages are achieved in accordance with the invention by a method in which the at least one second sensor is environmentally decoupled from the first technical device, and a correlation function is calculated by a processor with a memory, which is connected with the first and the at least one second sensor, using the first and the at least one second sensor data to estimate the background noise, to which background noise the first and the at least one second sensor are exposed simultaneously, and the correlation function is used to reduce the background noise of the first sensor data.

External sensors can be used in addition to the sensor on the motor to eliminate the noise and correct the distortion generated by the environment. Overall environmental noise, i.e., background noise, to which the first technical device and the at least one second technical device are exposed simultaneously, can be captured by the first and the at least one second sensor and further processed to remove background noise. The overall environmental impact applies to all sensors simultaneously.

The environmental decoupling between technical devices relates to the coupling caused from one technical device to another technical device directly, i.e., one technical device is the noise transmitter, and one other technical device is the recipient, and decoupled technical devices transfer ideally nothing to the others. However, background noise is generated by independent noise sources, which are not the technical devices themselves, and all technical devices are exposed to the background noise, but not necessarily in the same extent.

The first technical device and the at least one second technical device are independent and decoupled devices. The respective sensors capture operational emissions independently, but disturbed by background noise simultaneously as explained before.

With the disclosed invention, instead of certain assumptions, background noise induced by environmental effects can be measured directly with the help of an additional sensor. The data measured by a motor sensor will be corrected with the data from external sensors. The effective removal algorithms can be easily and effectively applied on the data in the application by the software compared to the current algorithms applied without any false alarms.

In the context of the present invention, environmentally coupling means an interrelation between two or more sensor parameter data by physical factors, such as a mechanical force or momentum, a time dependent behavior such as vibration as well as temperature or pressure and the like.

In the context of the present invention, environmentally decoupling means a much lower interrelation between two or more sensor parameters or data by physical factors as between coupled sensor parameters as defined just before. A decoupling between sensor data can be achieved by a signal ratio between two sensor parameters of at least the factor of 10, preferably by the factor of 100 and more preferably by the factor of 1000 or 10000.

In a further embodiment of the invention, the at least one second sensor is environmentally coupled to at least one second technical device. Accordingly, the second sensor can be used to capture sensor data from the second device as well as to capture background noise data for the further calculation of background noise data related to the first sensor. Consequently, a dual use of the second sensor can be achieved, which improves the system efficiency at all and lowers the system complexity and related costs.

In other words, the at least one second sensor is environmentally coupled to at least one second technical device and simultaneously environmentally decoupled from the first technical device. Consequently, the at least one second sensor is used to capture overall environmental or background noise, to which the first and the at least one second technical device are exposed, independently from each other because they are mounted on different, environmentally, e.g., mechanically decoupled technical devices.

In a further embodiment of the invention, the at least one second sensor is mounted stationary apart from the first and at least one second technical device. As a result, an isolation of general background noise related to noise produced individually by dedicated devices can be improved. The separation between sensor data of devices and generic noise can be performed in a simpler way, which allows the use of cheaper processors with simpler architectures, for instance, at edge devices.

In a further embodiment of the invention, the environmental coupling is affected by a mechanical factor, in particular vibration, by an environmental factor, in particular temperature or pressure, and/or an electric factor, in particular an electric field or a magnetic field.

A mechanical factor can be, for instance, vibration, which affects both the first and the at least second sensor simultaneously.

An environmental factor can be for instance temperature or pressure, which affects both the first and the at least second sensor simultaneously.

An electrical factor can be, for instance, a static or a dynamic magnetic or electric field, which affects both the first and the at least second sensor simultaneously.

Such a factor can be sensed directly or indirectly by a sensor by a related physical measurand, such as the magnitude of a vibration or a temperature or the magnetic field strength.

The objects and advantages are also achieved in accordance with the invention by a system for improving the signal quality of a first sensor data, where the system comprises a first sensor configured to capture the first sensor data, at least one second sensor configured to capture at least one second sensor data and a processor with a memory, which is connected with the first and the at least one second sensor and which is configured to receive the first and the at least one second sensor data, where the first sensor is environmentally coupled to a first technical device, where the at least one second sensor is environmentally decoupled from the first technical device, and the first and at least one second sensors are configured such that they are simultaneously exposed to background noise, and the processor is configured to calculate a correlation function using the first and the at least one second sensor data to estimate the background noise. In addition, the system is configured to implement the method in accordance with the disclosed embodiments of invention, where the correlation function is used to the reduce the background noise related at the first sensor data.

In a further embodiment of the invention, the at least one second sensor is mounted stationary and apart from the first and at least one second technical devices. This allows an easy determination of the background noise related at the first sensor data by the processor due to a decoupling from impacts by the other, i.e., the at least one second technical device, which can be often subject of generating own noise, which influences the general background noise negatively. Such a solution is preferred by simple edge devices providing a simple architecture for the processor.

In a further embodiment of the invention, the at least one second sensor is environmentally coupled to at least one second technical device. As a result, it is not necessary to include an additional second sensor and the sensor of a further technical device can be co-used, which reduces the system complexity. In addition, when considering the at least one second sensor the background noise, which is also influenced by the at least one second sensor itself, can be analyzed in a differentiating way, i.e., the noise of the at least one second sensor can be distinguished better due to the direct coupling to the at least one second device.

In a further embodiment of the invention, the at least one second sensor is coupled for direct communication purposes to the first sensor.

In the context of the present invention direct communication purposes mean, for instance, a peer-to-peer communication.

The direct communication allows the capture of sensor data, which are, for instance, inside the wireless coverage of a first and second sensors. Supporting such data transmission, the sensors are equipped with communication radios providing a two-way communication, implemented, for instance, by a 5G cellular network, a local Bluetooth network or a local Wi-Fi network or similar. A single network element, as defined by the radios, can forward sensor data to the processor.

In essence, the processor can be optionally implemented within a device, which itself incorporates a sensor.

Thus, a mesh sensor network can be obtained and the network for the sensor data transmission from the dedicated sensor to the processor can be simplified.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention is described in an exemplary embodiment with the attached figure in detail, in which:

FIG. 1 is schematic illustration of a system for improving the signal quality of a sensor in accordance with the invention; and

FIG. 2 is flowchart of the method in accordance with the invention.

### DETAILED DESCRIPTION OF THE EXEMPLARY EMBODIMENTS

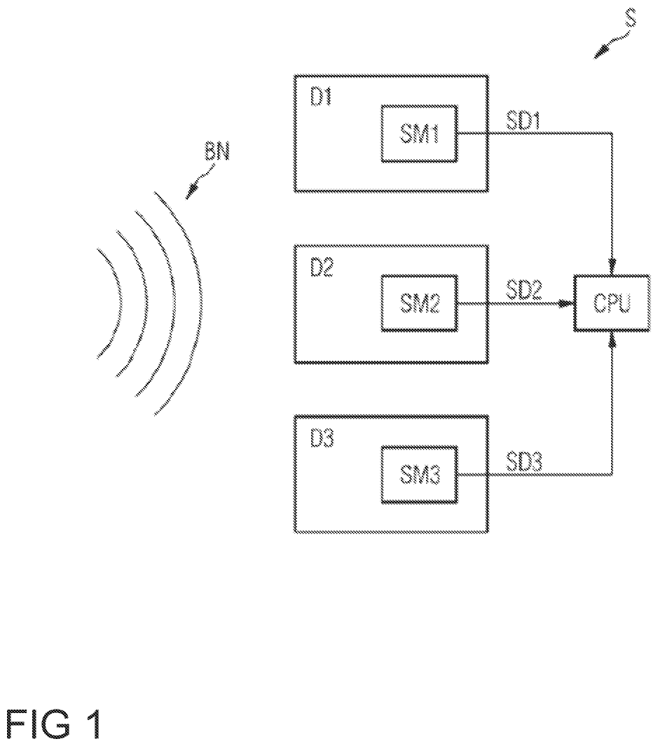

FIG. 1 shows a system S according to the invention for improving the signal quality of first sensor data SD1.

The system S comprises a first sensor SM1, which is configured to capture the first sensor data SD1.

Moreover, the system S comprises two second sensors SM2, SM3, which are configured to capture respective second sensor data SD2, SD3.

The system S additionally comprises a processor CPU with a memory, which is connected with the first and the two second sensors SM1-SM3, and which is configured to receive the first and the two second sensor data SD1-SD3.

The second sensors SM2, SM3 optionally can be coupled for direct communication purposes to the first sensor SM1, for instance, by a wireless mesh network.

The first sensor SM1 is environmentally coupled to a first technical device D1.

The two second sensors SM2, SM3 are environmentally decoupled from the first technical device D1 respectively.

The first and the two second sensors SM1, SM2, SM3 are configured such that they are exposed simultaneously to a background noise BN.

Additional sensors can be foreseen to measure for instance temperature, magnetic field, vibration, or acoustic signals.

Such sensors can be placed near to the motors D1, D2, D3.

The sensors SM1, SM2, SM3 can be realized by a Siemens sensor model SC400, which has built-in wireless and Bluetooth modules to accomplish the communication with external sensors.

Other solutions isolating the motor from external factors are mostly expensive and often require extra equipment.

An additional sensor can be mounted at the wall to improve the wireless range.

The device D1 can be mounted in a appropriate position so as to be aware of the environment in a reliable way.

The processor CPU is configured to calculate a correlation function using the first and one or two of the two second sensor data SD1, SD2, SD3 to estimate the background noise BN.

The system S is configured to implement the method in accordance with the invention, where the correlation function is used to the reduce the background noise BN related of the first sensor data SD1.

The second sensors SM2, SM3 are environmentally coupled to the respective technical devices D2, D3.

It is clear, that further parts that are not illustrated for purposes of clarity are necessary for the operation of a stator within an electrical drive, for instance, mounting parts, electric connection to a power supply and electronic control components. For the sake of a better understanding these parts are not illustrated and described, however.

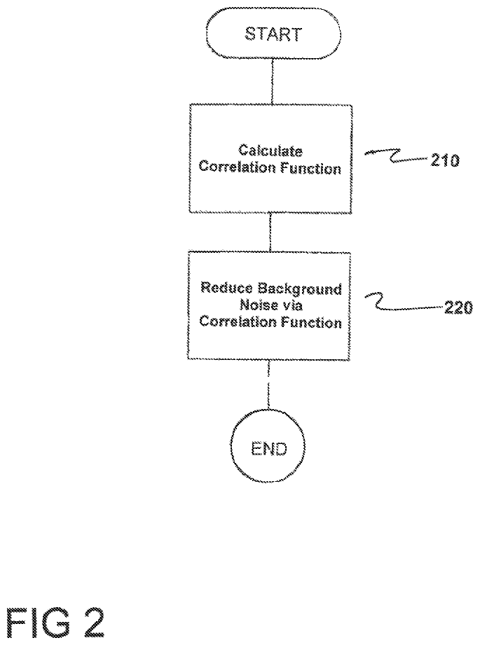

FIG. 2 is a flowchart of the computer-implemented method for improving the signal quality of a first sensor data SD1, where the first sensor data SD1 is captured by a first sensor SM1 that is environmentally coupled to a first technical device D1, and at least one second sensor data SD2, SD3 is captured by at least one second sensor SM2, SM3 that is environmentally decoupled from the first technical device D1.

The method comprises calculating, by a processor (CPU) including memory, a correlation function, utilizing the first and the at least one second sensor data SD1, SD2, SD3 to estimate the background noise BN, as indicated in step 210. In accordance with the invention, the first and the at least one second sensor SM1, SM2, SM3 are simultaneously exposed to background noise BN and the processor is connected to the first and the at least one second sensor SM1, SM2, SM3.

Next, the correlation function is used to reduce the background noise BN of the first sensor data SD1, as indicated in step 220. In accordance with the invention, the at least one second sensor SM2, SM3 is environmentally coupled to at least one second technical device D2, D3.

The invention is not restricted to the specific embodiments described in detail herein, but encompasses all variants, combinations and modifications thereof that fall within the framework of the appended claims.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps that perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-8. (canceled)

9. A computer-implemented method for improving signal quality of a first sensor data, the first sensor data being captured by a first sensor which is environmentally coupled to a first technical device, and at least one second sensor data being captured by at least one second sensor which is environmentally decoupled from the first technical device, the method comprising:
calculating, by a processor including memory, a correlation function, utilizing the first and the at least one second sensor data to estimate the background noise, the first and the at least one second sensor being exposed simultaneously to background noise and the processor being connected to the first and the at least one second sensor; and
reducing the background noise of the first sensor data via correlation function, wherein the at least one second sensor is environmentally coupled to at least one second technical device.

10. The method according to claim 9, wherein the at least one second sensor is mounted stationary and spaced apart from the first and at least one second technical device.

11. The method according to claim 9, wherein the environmental coupling is affected by at least one of a mechanical factor, an environmental factor, and an electrical factor.

12. The method according to claim 11, wherein the mechanical factor is a vibration, the environmental factor comprises temperature or pressure and where the electrical factor comprises an electric or a magnetic field.

13. A system for improving a signal quality of a first sensor data, the system comprising:
a first sensor configured to capture the first sensor data;
at least one second sensor configured to capture at least one second sensor data; and
a processor including memory, which is connected to the first and the at least one second sensor and which is configured to receive the first and at least one second sensor data;
wherein the first sensor is environmentally coupled to a first technical device;
wherein the at least one second sensor is environmentally decoupled from the first technical device;
wherein the first and at least one second sensing sensor are configured such that said first and at least one second sensing sensor are simultaneously exposed to background noise;
wherein the processor is configured to calculate a correlation function utilizing the first and at least one second sensor data to estimate the background noise;
wherein the correlation function is utilized to reduce background noise related to the first sensor data; and
wherein the at least one second sensor is environmentally coupled to at least one second technical device.

14. The system according to claim 13, wherein the at least one second sensor is mounted stationary and space apart from the first and at least one second technical device.

15. The system according to claim 13, wherein the at least one second sensor is coupled for direct communication purposes to the first sensor.

16. The system according to claim 14, wherein the at least one second sensor is coupled for direct communication purposes to the first sensor.
